(19) United States
(12) Patent Application Publication
(10) Pub. No.: US 2016/0186485 A1
(43) Pub. Date: Jun. 30, 2016

(54) Pet Door Assembly

(71) Applicant: James Taylor, Evansville, IN (US)

(72) Inventor: James Taylor, Evansville, IN (US)

(21) Appl. No.: 14/587,269

(22) Filed: Dec. 31, 2014

(51) Int. Cl. E06B 7/32; E05F 15/77; G07C 9/00; E05F 15/611; E05B 47/00; E05B 65/06; E05F 15/76; E06B 11/02

(52) U.S. Cl. CPC E06B 7/32; E05F 15/76; E05F 15/77; E06B 11/022; E05F 15/611; E05B 47/0001; E05B 65/06; G07C 9/00309; E05B 2047/0072; G07C 2009/00769

(57) ABSTRACT

A pet door assembly includes a first door coupled to a building. A collar may be worn by a pet. A transmitter is coupled to the collar. A frame positioned within the first door to define an opening through the first door and a second door is hingedly coupled to the frame. A pair of receivers is each coupled to the door. A control circuit is coupled to the frame. A receiver is coupled to the frame, the transmitter and the control circuit. The control circuit defines a trigger distance between the receiver and the transmitter. A pair of locks is each coupled to the second door and the control circuit. The locks are actuatable into a locked position to engage the receivers when the transmitter is moved out of the trigger distance. The locks are actuated into an unlocked position when the transmitter is moved within the trigger distance.

### BACKGROUND OF THE DISCLOSURE

### Field of the Disclosure

The disclosure relates to door devices and more particularly pertains to a new door device for automatically opening to allow a pet to enter a building.

### SUMMARY OF THE DISCLOSURE

An embodiment of the disclosure meets the needs presented above by generally comprising a first door coupled to a building. A collar may be worn by a pet. A transmitter is coupled to the collar. A frame positioned within the first door to define an opening through the first door. A second door is hingedly coupled to the frame. A pair of receivers is each coupled to the door. A control circuit is coupled to the frame. The control circuit is in wireless communication with the collar. A receiver is positioned within the frame. The receiver is in wireless communication with the transmitter. The receiver is electrically coupled to the control circuit. The control circuit determines a distance between the receiver and the transmitter. The control circuit defines a trigger distance between the receiver and the transmitter. A pair of locks is each coupled to the second door. The locks are electrically coupled to the control circuit. The locks are actuatable into a locked position to engage the receivers. The second door is retained in the closed position when the transmitter is moved out of the trigger distance. The locks are actuated into an unlocked position when the transmitter is moved within the trigger distance.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a pet door assembly according to an embodiment of the disclosure.

FIG. 2 is a top view of an embodiment of the disclosure.

FIG. 3 is a front view of an embodiment of the disclosure.

FIG. 4 is a back view of an embodiment of the disclosure.

FIG. 5 is a front perspective view of an embodiment of the disclosure.

FIG. 6 is an in-use view of an embodiment of the disclosure.

FIG. 7 is a schematic view of an embodiment of the disclosure.

### DESCRIPTION OF THE PREFERRED EMBODIMENT

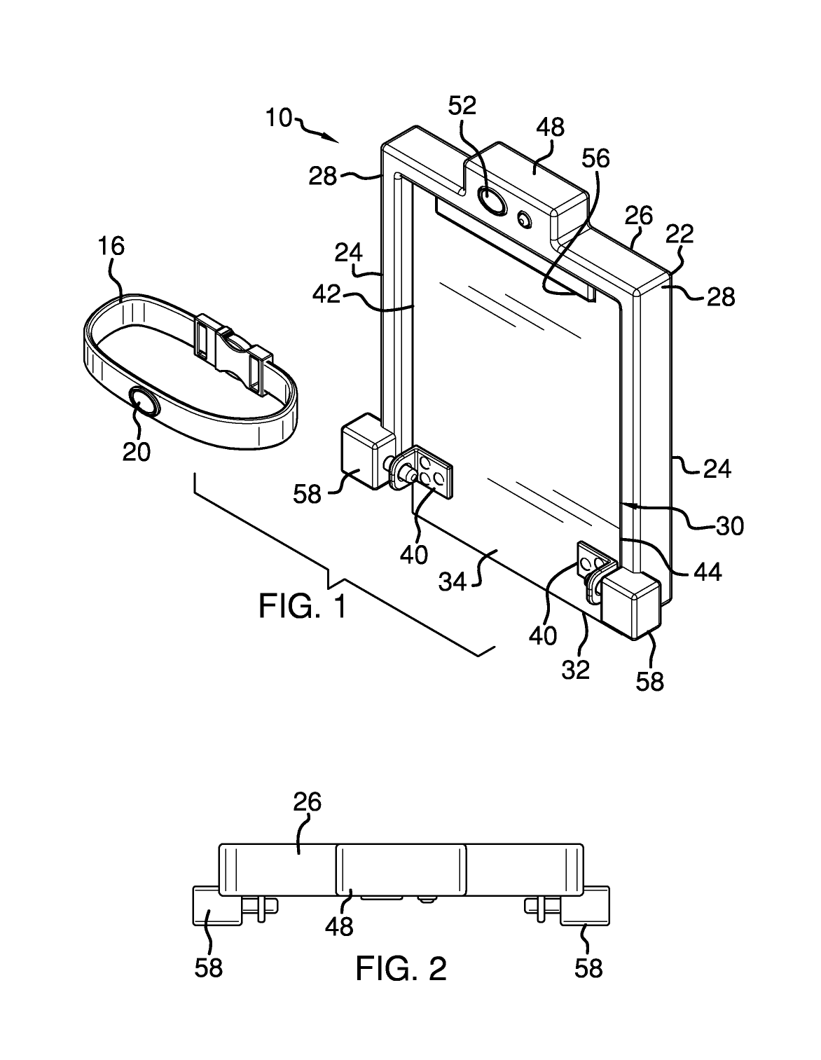

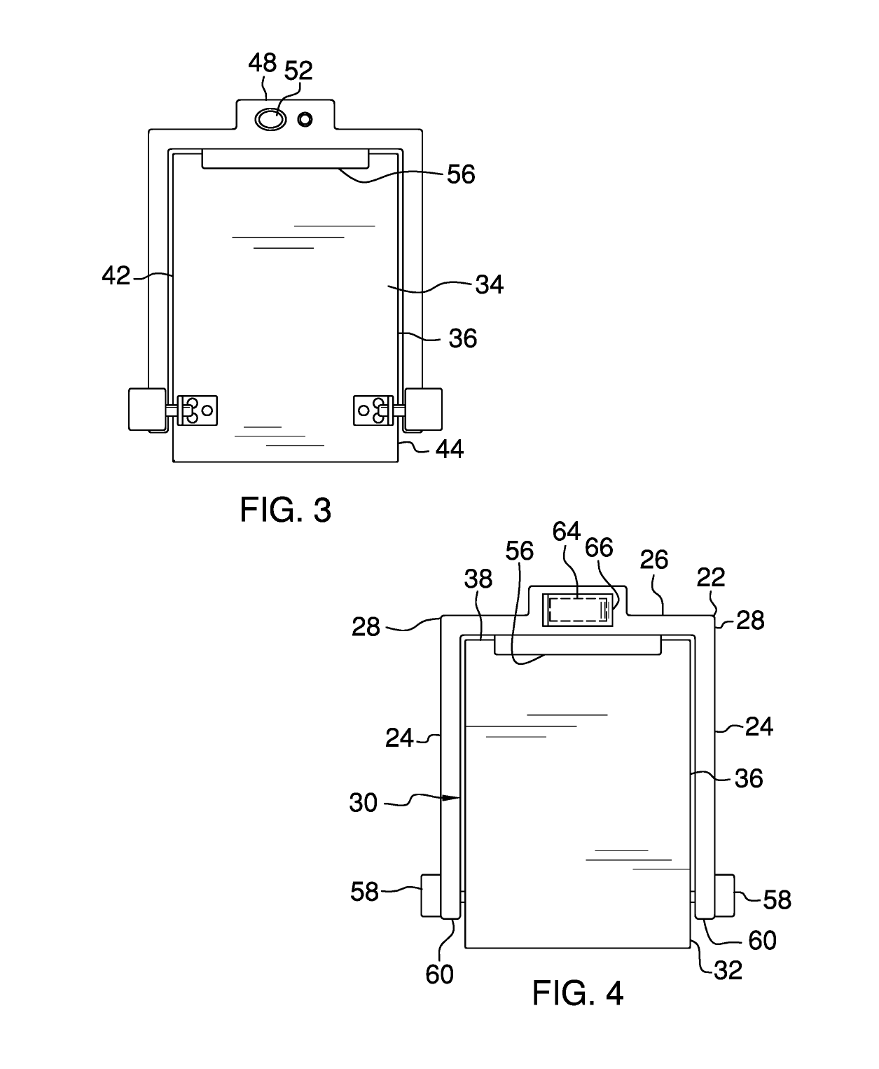

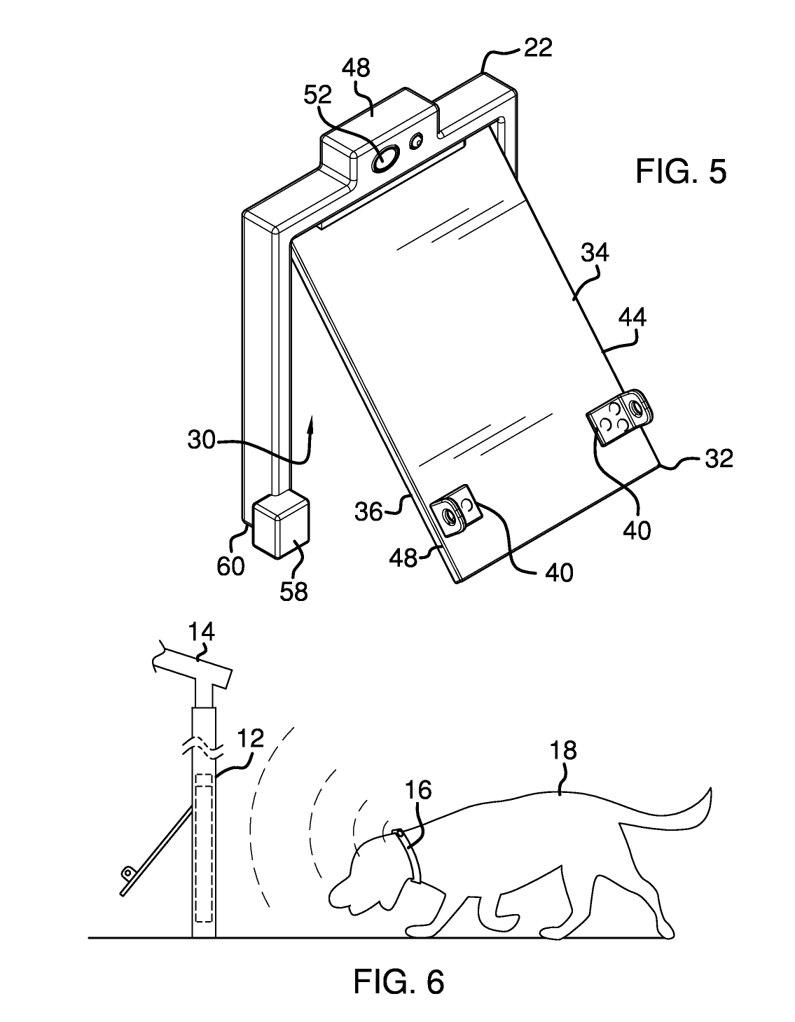

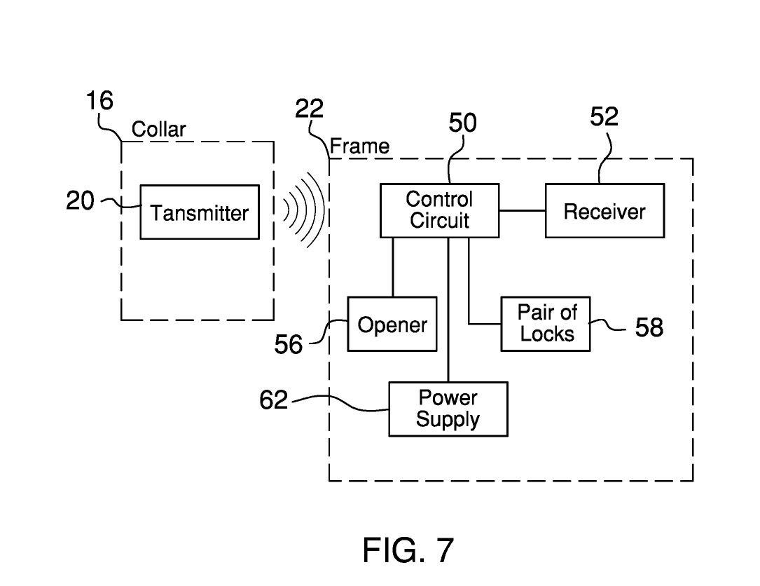

With reference now to the drawings, and in particular to FIGS. 1 through 7 thereof, a new door device embodying the principles and concepts of an embodiment of the disclosure and generally designated by the reference numeral 10 will be described.

As best illustrated in FIGS. 1 through 7, the pet door assembly 10 generally comprises a first door 12 coupled to a building 14 such as the entry door for a dwelling. A collar 16 is provided. The collar 16 may be worn by a pet 18 that may be a dog or cat or other domesticated animal. A transmitter 20 is coupled to the collar 16. The transmitter 20 may be a radio frequency transmitter or the like.

A frame 22 is provided and has a pair of vertical legs 24 and a central leg 26 coupled to and extending between the vertical legs 24. The central leg 26 is positioned adjacent to a top end 28 of the vertical legs 24. The frame 22 is positioned within the door 12 to define an opening 30 through the first door 12.

A second door 32 has a front side 34 and an outer edge 36. A top side 38 of the outer edge 36 is hingedly coupled to the central leg 26. The second door 32 extends between the vertical legs 24. A pair of receivers 40 is each coupled to the front side 34. Each of the receivers 40 is positioned adjacent to an associated one of a first lateral side 42 and a second lateral side 44 of the outer edge 36. The central leg 26 may have a control housing 48. A control circuit 50 is coupled to the frame 22. The control circuit 50 may be positioned within the control housing 48.

A receiver 52 is positioned within the frame 22. The receiver 52 may be positioned within the control housing 48. The receiver 52 may be a radio frequency receiver or the like and is in wireless communication with the transmitter 20. The receiver 52 is electrically coupled to the control circuit 50. The control circuit 50 continually measures a signal strength of the transmitter 20 to determine a distance between the receiver 52 and the transmitter 20. Moreover, the control circuit 50 defines a trigger distance between the receiver 52 and the transmitter 20. The trigger distance may be a distance approximately between 1 foot and 3 feet.

An opener 56 is coupled to between the central leg 26 and the second door 32. The opener 56 is electrically coupled to the control circuit 50 and positions the second door 32 in an open position when the transmitter 20 is moved within the trigger distance. The opener 56 positions the second door 32 in a closed position when the transmitter 20 is moved out of the trigger distance. The opener 56 may be an electrically operated motor and gear coupled to the second door 32 or another conventional automatic door opening mechanism.

A pair of locks 58 is each coupled to one of the vertical legs 24. Each of the locks 58 is positioned adjacent to a bottom end 60 of the vertical legs 24. The locks 58 are electrically coupled to the control circuit 50. The locks 58 are actuatable into a locked position to engage the receivers 40. The locks 58 retain the second door 32 in the closed position when the transmitter 20 is moved out of the trigger distance. The locks 58 are actuated into an unlocked position when the transmitter 20 is moved within the trigger distance. Each of the locks 58 may be electrically operated solenoids or the like. Additionally, each of the locks 58 may engage the opener 56 to retain the second door 32 in the closed position. The opener 56 may have a locking function to retain the second door 32 in the closed position. The locks 58 may each engage the first 42 and second 44 lateral sides of the second door 32.

A power supply 62 is positioned within the frame 22. The power supply 62 may be positioned within the control housing 48 and is electrically coupled to the control circuit 50. The power supply 62 may comprise at least one battery 64. A battery cover 66 is removably coupled to the central leg 26 and the power supply 62 is positioned beneath the battery cover 66.

In use, the assembly 10 prevents unwanted animals from entering the building 14. The collar 16 is worn by the pet 18 to allow the pet 18 to enter and exit the building 14. The assembly 10 is utilized in the convention of a pet door while preventing the second door 32 from opening without receiving the wireless signal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet door assembly configured to automatically open when a pet approaches the pet door, said assembly comprising:
a first door coupled to a building;
a collar configured to be worn by a pet;
a transmitter coupled to said collar;
a frame positioned within said first door to define an opening through said first door, wherein said frame has a pair of vertical legs and a central leg coupled to and extending between said vertical legs, said central leg being positioned adjacent to a top end of said vertical legs;
a second door being hingedly coupled to said frame, wherein said second door has a front side and an outer edge, a top side of said outer edge being hingedly coupled to said central leg, said second door extending between said vertical legs;
a pair of lock receivers each coupled to said second door, wherein each of said lock receivers includes a first planar section coupled to said front side and a second planar section perpendicular to said first section such that said second section extends perpendicularly out from said front side of said second door, each of said lock receivers being positioned adjacent to an associated one of a first lateral side and a second lateral side of said outer edge;
a control circuit coupled to said frame;
a wireless receiver positioned within said frame, said wireless receiver being in wireless communication with said transmitter, said wireless receiver being electrically coupled to said control circuit, said control circuit determining a distance between said wireless receiver and said transmitter thereby defining a trigger distance between said wireless receiver and said transmitter; and
a pair of locks each coupled to said frame, said locks being electrically coupled to said control circuit, said locks being actuatable into a locked position to engage said lock receivers thereby retaining said second door in said closed position when said transmitter is moved out of said trigger distance, said locks being actuated into an unlocked position when said transmitter is moved within said trigger distance.

2. (canceled)

3. (canceled)

4. (canceled)

5. The assembly according to claim 1, further comprising an opener coupled to between said central leg and said second door, said opener being electrically coupled to said control circuit.

6. The assembly according to claim 5, wherein said opener positions said second door in an open position when said transmitter is moved within said trigger distance, said opener positioning said second door in a closed position when said transmitter is moved out of said trigger distance.

7. The assembly according to claim 1, wherein said locks are coupled to said vertical legs, each of said locks being positioned adjacent to a bottom end of said vertical legs.

8. The assembly according to claim 1, further including a power supply positioned within said central leg, said power supply being electrically coupled to said control circuit, said power supply comprising at least one battery.

9. A pet door assembly configured to automatically open when a pet approaches the pet door, said assembly comprising:
a first door coupled to a building;
a collar configured to be worn by a pet;
a transmitter coupled to said collar;
a frame having a pair of vertical legs and a central leg coupled to and extending between said vertical legs, said central leg being positioned adjacent to a top end of said vertical legs, said frame being positioned within said first door to define an opening through said first door;
a second door having a front side and an outer edge, a top side of said outer edge being hingedly coupled to said central leg, said second door extending between said vertical legs;
a pair of lock receivers, wherein each lock receiver includes a first planar section coupled to said front side and a second planar section perpendicular to said first section such that said second section extends perpendicularly out from said front side of said second door, each of said lock receivers being positioned adjacent to an associated one of a first lateral side and a second lateral side of said outer edge;
a control circuit coupled to said frame;
a wireless receiver positioned within said frame, said wireless receiver being in wireless communication with said transmitter, said wireless receiver being electrically coupled to said control circuit, said control circuit determining a distance between said wireless receiver and said transmitter thereby defining a trigger distance between said wireless receiver and said transmitter;
an opener coupled to between said central leg and said second door, said opener being electrically coupled to said control circuit, said opener positioning said second door in an open position when said transmitter is moved within said trigger distance, said opener positioning said second door in a closed position when said transmitter is moved out of said trigger distance;
a pair of locks each coupled to said vertical legs, each of said locks being positioned adjacent to a bottom end of said vertical legs, said locks being electrically coupled to said control circuit, said locks being actuatable into a locked position to engage said lock receivers thereby retaining said second door in said closed position when said transmitter is moved out of said trigger distance, said locks being actuated into an unlocked position when said transmitter is moved within said trigger distance; and
a power supply positioned within said central leg, said power supply being electrically coupled to said control circuit, said power supply comprising at least one battery.
